(19) United States
(12) Patent Application Publication
(10) Pub. No.: US 2026/0369820 A1
(43) Pub. Date: Nov. 19, 2026

(54) BATTERY ASSEMBLY WITH COMPOSITE ENCLOSURE

(71) Applicant: GM Global Technology Operations LLC, Detroit, MI (US)

(72) Inventor: Andrew Geoffrey Balding, Wixom, MI (US)

(73) Assignee: GM Global Technology Operations LLC, Detroit, MI (US)

(21) Appl. No.: 19/212,256

(22) Filed: May 19, 2025

(51) Int. Cl. H01M 50/507; H01M 50/204; H01M 50/224; H01M 50/227; H01M 50/249; H01M 50/296; H01M 50/509; H01M 50/522

(52) U.S. Cl. CPC H01M 50/507; H01M 50/204; H01M 50/224; H01M 50/227; H01M 50/249; H01M 50/296; H01M 50/509; H01M 50/522; H01M 2220/20

(57) ABSTRACT

A battery assembly has a positive terminal and a negative terminal. The battery assembly includes a first structural member electrically coupled to the negative terminal of the battery assembly and a second structural member electrically coupled to the positive terminal of the battery assembly. A first battery cell is electrically coupled to the negative terminal via the first structural member. The first battery cell is electrically coupled to the positive terminal via the second structural member. A composite enclosure envelops the first structural member, the second structural member, and the first battery cell. The first structural member and the second structural member are integral with the composite enclosure.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to battery assemblies configured to power large equipment, such as a vehicle. More specifically, it addresses electrical bussing and structural members used to bolster battery assemblies.

A battery assembly often includes various battery components, such as battery cells or battery cell arrays (i.e., a plurality of battery cells electrically connected to one another in series), an electrical bus (i.e., conductive material) that connects battery cells to one another and/or to terminals of the battery assembly, and structural components that increase structural integrity of the battery assembly. The battery components may be fastened to a battery enclosure via screws, bolts, adhesive, retention clips, clamps, and/or weld joints. The battery enclosure may include a stamped metal or composite tray and a lid that envelops the battery components.

The electrical bus and structural components may increase a volume and/or a weight of the battery assembly without increasing energy density (i.e., the amount of energy the battery assembly can store relative to the volume and/or the weight of the battery assembly) of the battery assembly. The electrical bus may include wires, wire harnesses, or bus bars of highly conductive metal, which may be enveloped by conduit or insulation. Structural components may include plates or beams of high-strength metal or composite materials extending along and/or across the battery enclosure. By reducing energy density of the battery assembly, the battery assembly may be more difficult to package into a vehicle or equipment, limiting its potential use applications. In vehicular applications, reduced energy density may further reduce energy efficiency of the vehicle powered by the battery assembly and may result in reduced range of the vehicle. Therefore, there is a need for an improved battery assembly in which packaging of the electrical bus is minimized and/or consolidated with structural components of the battery assembly in order to maximize the energy density of the battery assembly.

### SUMMARY

In some aspects, a battery assembly has a positive terminal and a negative terminal. The battery assembly includes a first structural member electrically coupled to the negative terminal of the battery assembly and a second structural member electrically coupled to the positive terminal of the battery assembly. A first battery cell is electrically coupled to the negative terminal via the first structural member. The first battery cell is electrically coupled to the positive terminal via the second structural member. A composite enclosure envelops the first structural member, the second structural member, and the first battery cell. The first structural member and the second structural member are integral with the composite enclosure.

In some examples, a third structural member may be disposed along a first side of the first battery cell and a fourth structural member may be disposed along a second side of the first battery cell. In other examples, the first structural member may extend along a first side of the composite enclosure, the second structural member may extend along a second side of the composite enclosure, and the third structural member and the fourth structural member may each extend from the first structural member to the second structural member. In further examples, a second battery cell may be electrically coupled to the first battery cell via the fourth structural member. The first battery cell electrically couples the second battery cell to the negative terminal via the first structural member, and the second battery cell electrically couples the first battery cell to the positive terminal via the second structural member.

In some configurations, a third battery cell may be electrically coupled to the negative terminal via the first structural member, and a fourth battery cell may be electrically coupled to the positive terminal via the second structural member. A fifth structural member may be disposed between the third battery cell and the fourth battery cell. The third battery cell may be electrically coupled to the fourth battery cell via the fifth structural member. Optionally, the first battery cell is electrically coupled in series with the second battery cell, the third battery cell is electrically coupled in series with the fourth battery cell, and the first battery cell and the second battery cell are together electrically coupled in parallel with the third battery cell and the fourth battery cell.

In some examples, the first structural member and the second structural member may include at least one of aluminum, steel, iron, and titanium. In other examples, the first battery cell may include a plurality of battery cells electrically coupled to one another to form a battery cell array. In further examples, the composite enclosure may be configured to insulate each of the first structural member and the second structural member. Additionally or alternatively, the first battery cell is integral with the composite enclosure. Optionally, a vehicle may include the battery assembly.

In other aspects, a battery assembly has a positive terminal and a negative terminal. The battery assembly includes a first structural member electrically coupled to the negative terminal of the battery assembly and a second structural member electrically coupled to the positive terminal of the battery assembly. A first battery cell is electrically coupled to the negative terminal via the first structural member. A third structural member is electrically coupled to the first battery cell and disposed along a first side of the first battery cell. A second battery cell is electrically coupled in series with the first battery cell via the third structural member. The third structural member is disposed along the first side of the first battery cell and a first side of the second battery cell. The second battery cell is electrically coupled to the positive terminal via the second structural member. A composite enclosure envelops the first structural member, the second structural member, the third structural member, the first battery cell, and the second battery cell. The first structural member, the second structural member, and the third structural member are integral with the composite enclosure.

In some configurations, the first structural member may extend along a first side of the composite enclosure, the second structural member may extend along a second side of the composite enclosure, and the third structural member may extend from the first structural member to the second structural member. In some examples, a fourth structural member may be disposed along a second side of the first battery cell opposite the first side of the first battery cell, and a fifth structural member may be disposed along a second side of the second battery cell opposite the first side of the second battery cell. In other examples, a third battery cell may be electrically coupled to the negative terminal via the first structural member, and a fourth battery cell may be electrically coupled to the positive terminal via the second structural member. A fourth structural member may be disposed between the third battery cell and the fourth battery cell, the third battery cell being electrically coupled in series with the fourth battery cell via the fourth structural member.

In some configurations, the first structural member, the second structural member, and the third structural member may include at least one of aluminum, steel, iron, and titanium. In other configurations, the first battery cell may include a first plurality of battery cells electrically coupled to one another to form a first battery cell array, and the second battery cell may include a second plurality of battery cells electrically coupled to one another to form a second battery cell array. In further configurations, the composite enclosure may include plastic integrally formed about the first structural member, the second structural member, the first battery cell, and the second battery cell via plastic over-molding. Optionally, the composite enclosure insulates each of the structural members and each of the battery cells.

In further aspects, a battery assembly for a vehicle has a positive terminal and a negative terminal. The battery assembly includes a first structural member extending along a first side of the battery assembly and electrically coupled to the negative terminal of the battery assembly and a second structural member extending along a second side of the battery assembly and electrically coupled to the positive terminal of the battery assembly. A first battery cell array is electrically coupled to the negative terminal via the first structural member. A third structural member is disposed along a first side of the first battery cell array. A second battery cell array is electrically coupled to the positive terminal via the second structural member and electrically coupled in series with the first battery cell array via the third structural member disposed along the first side of the first battery cell array and a first side of the second battery cell array. A fourth structural member is disposed along a second side of the first battery cell array opposite the first side of the first battery cell array. A fifth structural member is disposed along a second side of the second battery cell array opposite the first side of the second battery cell array. A third battery cell array is electrically coupled to the negative terminal via the first structural member. A fourth battery cell array electrically coupled to the positive terminal via the second structural member. A sixth structural member is disposed between the third battery cell array and the fourth battery cell array. The third battery cell array is electrically coupled in series with the fourth battery cell array via the sixth structural member. A composite enclosure is over-molded about each of the structural members and each of the battery cell arrays. The composite enclosure insulates each of the structural members and each of the battery cell arrays.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle including a battery assembly according to the present disclosure;

FIG. 2 is a perspective view of the battery assembly according to the present disclosure;

FIG. 3 is a cross-sectional view of the battery assembly of FIG. 2 taken along Lines A-A in FIG. 2;

FIG. 4 is a cross-sectional view of the battery assembly of FIG. 2 taken along Lines B-B in FIG. 3;

FIG. 5 is a cross-sectional view of the battery assembly of FIG. 2 taken along Lines C-C in FIG. 3; and

FIG. 6 is a block diagram of a battery assembly including a first electrical pathway and a second electrical pathway according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a battery cell array; a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM) / erasable programmable read-only memory (EPROM)/ electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

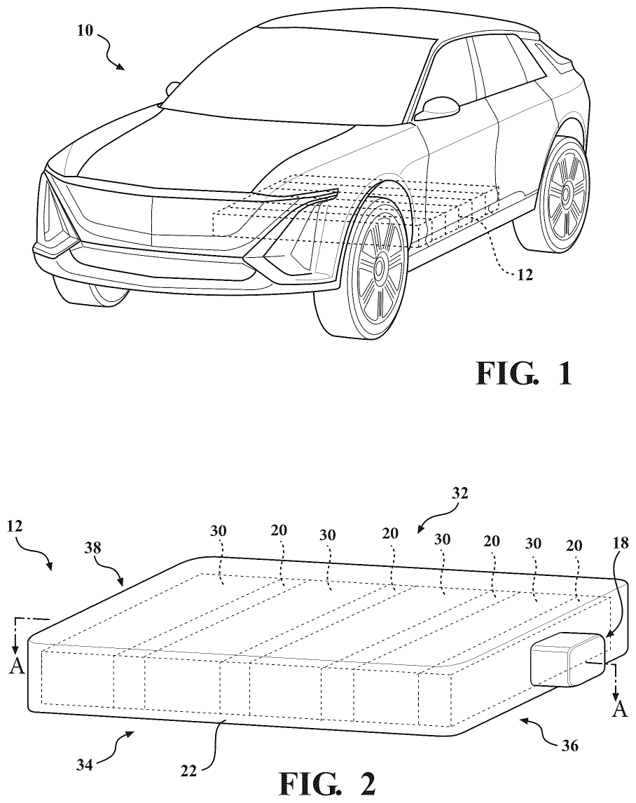

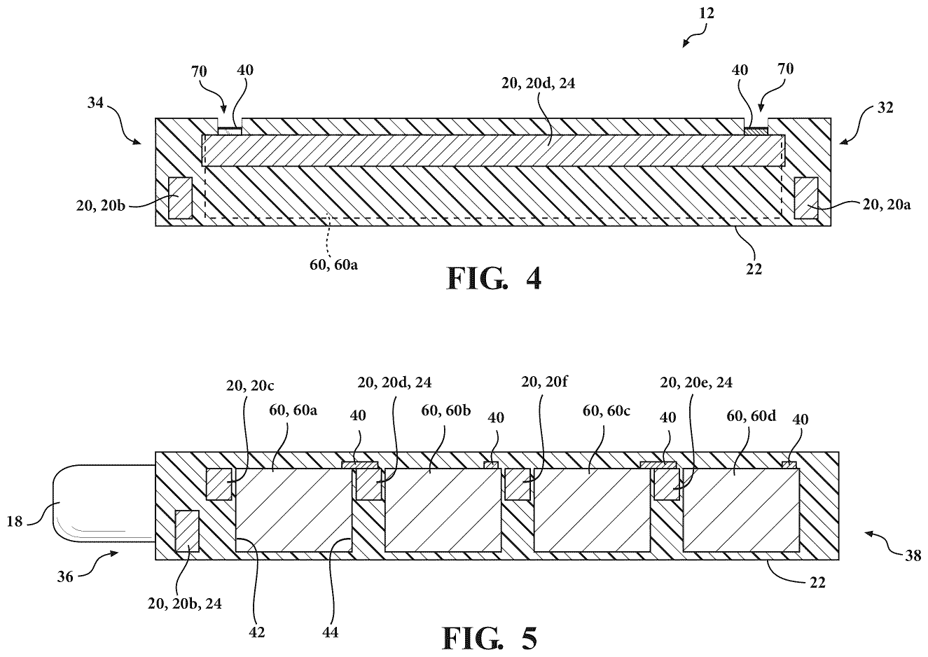

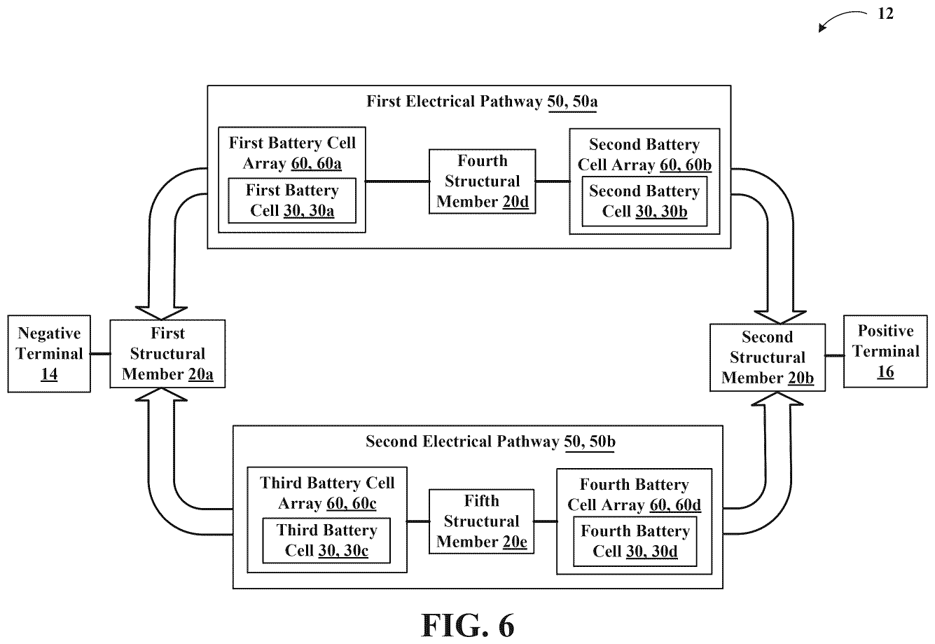

Referring to FIGS. 1-6, a vehicle 10 includes a battery assembly 12 (i.e., a rechargeable energy storage system (RESS) or a battery pack), such as a lithium-ion battery assembly, configured to at least partially power the vehicle 10. For example, the vehicle 10 may be an electric vehicle (EV) or a hybrid vehicle equipped with the battery assembly 12 and an internal combustion engine (ICE). The battery assembly 12 includes a negative terminal 14 (i.e., an anode) and a positive terminal 16 (i.e., a cathode) at which EV components powered by the battery assembly 12 may be coupled. In some examples, the terminals 14, 16 may be located at a battery disconnect unit (BDU) 18 (i.e., an electrical controller or a central processing unit (CPU) that controls electrical charging and discharging of the battery assembly 12). The battery assembly 12 includes a plurality of structural members 20 and a composite enclosure 22 that envelops the plurality of structural members 20, as discussed further below.

In some embodiments, the structural members 20 increase structural integrity of the battery assembly 12 by increasing rigidity and strength of the composite enclosure 22. The structural members 20 may include at least one of aluminum, steel, iron, titanium, copper, a metal alloy, or any high-strength conductive material. Metals such as iron, steel, or titanium may increase the strength of the composite enclosure 22. Metals such as aluminum or titanium may reduce weight of the battery assembly 12 and therefore increase energy density of the battery assembly 12.

In other embodiments, the structural members 20 may together be an electrical bus 24 of the battery assembly 12 that electrically couple battery cells 30 to one another and/or to the terminals 14, 16 or the BDU 18. For example, a first structural member 20a may be electrically coupled the negative terminal 14, and a second structural member 20b may be electrically coupled to the positive terminal 16. A battery cell 30 (e.g., a cylindrical battery cell 30, a prismatic battery cell 30, a pouch battery cell 30, or any configuration of battery cell 30) may be electrically coupled to the negative terminal 14 via the first structural member 20a. The battery cell 30 may be electrically coupled to the positive terminal 16 via the second structural member 20b. In some examples, the first structural member 20a may extend along a first side 32 of the battery assembly 12, and the second structural member 20b may extend along a second side 34 of the battery assembly 12. Optionally, the first structural member 20a and the second structural member 20b may extend from a first end 36 of the battery assembly 12 to a second end 38 of the battery assembly 12.

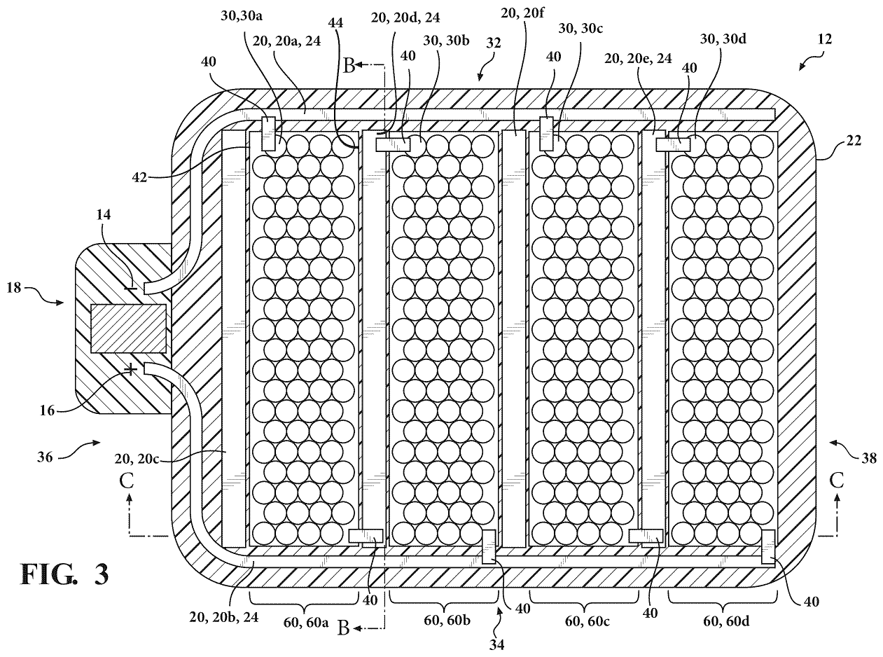

Referring to FIGS. 3-6, fasteners 40 may selectively couple the structural members 20 to one another, the positive terminal 16, the negative terminal 14, and/or battery cells 30. The fasteners 40 may include bolts, screws, connectors (e.g., male-to-female connectors or flanged connectors), and/or weld joints. Additionally or alternatively, the fasteners 40 may be points of contact between one or more structural members 20, between a structural member 20 and a terminal 14, 16, and/or between a structural member 20 and a battery cell 30. Optionally, fasteners 40 may selectively couple and/or be points of contact between a terminal 14, 16 and a battery cell 30, or between two or more battery cells 30. That is, the fasteners 40 may provide structural couplings (e.g., mechanical couplings), electrical couplings, or couplings that are both structural and electrical within the battery assembly 12.

The battery assembly 12 may include additional structural members 20 that extend between the first structural member 20a and the second structural member 20b and/or between the first side 32 and the second side 34 of the battery assembly 12. For example, a third structural member 20c may be disposed along a first side 42 of the battery cell 30, and a fourth structural member 20d may be disposed along a second side 44 of the battery cell 30. The third structural member 20c and the fourth structural member 20d may each extend from the first structural member 20a to the second structural member 20b. Additionally or alternatively, the third structural member 20c and the fourth structural member 20d may each extend from the first side 32 to the second side 34 of the battery assembly 12.

The battery assembly 12 may include additional battery cells 30. The battery cells 30 may be electrically coupled to one another via the electrical bus 24. In one example, a first battery cell 30a may be electrically coupled to a second battery cell 30b via the fourth structural member 20d. The first battery cell 30a may electrically couple the second battery cell 30b to the negative terminal 14 via the first structural member 20a. The second battery cell 30b may electrically couple the first battery cell 30a to the positive terminal 16 via the second structural member 20b.

In another example, a third battery cell 30c may be electrically coupled to the negative terminal 14 via the first structural member 20a. A fourth battery cell 30d may be electrically coupled to the positive terminal 16 via the second structural member 20b. A fifth structural member 20e may be disposed between the third battery cell 30c and the fourth battery cell 30d, and the third battery cell 30c may be electrically coupled to the fourth battery cell 30d via the fifth structural member 20e. Optionally, additional structural members 20 may be disposed in the battery assembly 12 to further strengthen or bolster the composite enclosure 22. For example, a sixth structural member 20f may be disposed between the second battery cell 30b and the third battery cell 30c.

Referring still to FIGS. 3-6, the battery cells 30 and the structural members 20 may define a plurality of electrical pathways 50. For example, the first battery cell 30a electrically coupled in series with the second battery cell 30b via the fourth structural member 20d may define a first electrical pathway 50a from the first structural member 20a to the second structural member 20b. That is, the first electrical pathway 50a may be defined from the negative terminal 14 to the positive terminal 16 via the first battery cell 30a being electrically coupled in series with the second battery cell 30b. The third battery cell 30c electrically coupled in series with the fourth battery cell 30d via the fifth structural member 20e may define a second electrical pathway 50b from the first structural member 20a to the second structural member 20b. That is, the second electrical pathway 50b may be defined from the negative terminal 14 to the positive terminal 16 via the third battery cell 30c being electrically coupled in series with the fourth battery cell 30d. As a result of the arrangement of the battery cells 30a-30d with the first structural member 20a and the second structural member 20b, the first battery cell 30a and the second battery cell 30b may together be electrically coupled in parallel with the third battery cell 30c and the fourth battery cell 30d.

In some configurations, the battery assembly 12 may include battery cell arrays 60 (i.e., battery modules), in which a plurality of battery cells 30 are electrically coupled to one another in series. Multiple battery cell arrays 60 may be coupled to one another via the electrical bus 24. For example, a first battery cell array 60a including the first battery cell 30a may be electrically coupled to a second battery cell array 60b includes the second battery cell 30b via the fourth structural member 20d. A third battery cell array 60c including the third battery cell 30c may be electrically coupled to a fourth battery cell array 60d via the fifth structural member 20e. The battery assembly 12 may include any number or configuration of battery cells 30 and/or battery cell arrays 60. For example, the battery assembly 12 may be configured as a module-to-pack battery assembly 12, a cell-to-pack battery assembly 12, or other battery-cell enclosure configurations.

The battery cell arrays 60 and the structural members 20 may define the plurality of electrical pathways 50. The first electrical pathway 50a from the first structural member 20a to the second structural member 20b may be defined by the first battery cell array 60a being electrically coupled in series with the second battery cell array 60b via the fourth structural member 20d. The second electrical pathway 50b from the first structural member 20a to the second structural member 20b may be defined by the third battery cell array 60c being electrically coupled in series with the fourth battery cell array 60d via the fifth structural member 20e. As a result of the arrangement of the battery cell arrays 60a-60d with the first structural member 20a and the second structural member 20b, the first battery cell array 60a and the second battery cell array 60b may together be electrically coupled in parallel with the third battery cell array 60c and the fourth battery cell array 60d.

Referring still to FIGS. 3-6, the composite enclosure 22 envelops the structural members 20, such that the structural members 20 are integral with the composite enclosure 22. The structural members 20 add strength and rigidity to the composite enclosure 22, such that the composite enclosure 22 may be made from lightweight materials such as plastic. A thickness and quantity of material of the composite enclosure 22 may also be reduced. Additionally or alternatively, the composite enclosure 22 may envelop the battery assembly 12, such as the terminals 14, 16, BDU 18, battery cells 30, battery cell arrays 60, and/or fasteners 40. For example, the first battery cell 30a and the second battery cell 30b may be integral with the composite enclosure 22. Integrally forming the composite enclosure 22 about the structural members 20 reduces the fasteners 40 utilized in the battery assembly 12. Further, integrally forming the composite enclosure 22 about the structural members 20 reduces weight of the battery assembly 12 and/or reduces volume occupied by the structural members 20, increasing the energy density of the battery assembly 12.

The composite enclosure 22 may be configured to insulate the structural members 20, such that the structural members 20 are electrically isolated from one another and/or from the terminals 14, 16, BDU 18, battery cells 30, battery cell arrays 60, and/or fasteners 40. The composite enclosure 22 may also be configured to insulate the terminals 14, 16, BDU 18, battery cells 30, battery cell arrays 60, and/or fasteners 40, electrically isolating them from one another and/or from the structural members 20. Insulating the structural members 20 via the composite enclosure 22 prevents electrical arcing, short circuiting, or otherwise undesired electrical coupling between and/or among the structural members 20 and reduces the risk of thermal events occurring within the battery assembly 12.

The composite enclosure 22 may include recesses, cavities, channels, through-holes, pockets, and/or openings that create access points 70 where the terminals 14, 16, the BDU 18, the battery cells 30, the battery cell arrays 60, the fasteners 40 and/or the structural members 20 may be accessed from outside of the composite enclosure 22. That is, the access points 70 may provide for mechanical or electrical coupling, connection, and/or access to the structural members 20, the battery cells 30, the fasteners 40, the cell arrays 60, the terminals 14, 16, and/ or the BDU 18. The access points 70 may facilitate charging, maintenance, assembly, and/or integration of the battery assembly 12 with the vehicle 10. Additionally or alternatively, the access points 70 may be connection points that protrude from the composite enclosure 22, such as a terminal and/or a wiring harness interface (e.g., a plug, outlet, and/or a male-to-female connector). Optionally, an access point 70 may include a charging port, such that a charging-port connection may be made directly to the terminals 14, 16 and/or the BDU 18.

The composite enclosure 22 may be formed from a plastic that is over-molded about the structural members 20, such as via injection molding or squeeze forming. Optionally, the composite enclosure 22 may be formed from a plastic that is over-molded about the battery cells 30, the battery cell arrays 60, the fasteners 40, the terminals, 14, 16, and/or the BDU 18. The plastic may include material that increases strength of the composite enclosure 22. For example, the plastic may be glass-filled. Optionally, the plastic may be dielectric and/or flame retardant.

Referring to FIGS. 1-6, the battery assembly 12 may include the structural members 20 being integral with a composite enclosure 22, where the structural members 20 are configured as an electrical bus 24. The electrical bus 24 advantageously couples the battery cells 30 to one another and/or to the BDU 18. Integrating the structural members 20 into the composite enclosure 22 reduces space required to package the electrical bus 24 and reduces the number of fasteners 40, wiring harnesses, insulation, and the components utilized for assembly of the battery assembly 12. The battery assembly 12 can advantageously accommodate structural members 20 with larger cross-sections than an electrical bus 24 that is separate from or not integral with the composite enclosure 22. The structural members 20 may be aluminum, steel, iron, copper, and/or an alloy of these. Thus, the structural members 20 may increase strength and rigidity of the composite enclosure 22 and may increase structural integrity of the battery assembly 12 without additional structural elements. Integrating structural members 20 into the composite enclosure 22 increases the energy density of the battery assembly 12 by reducing volume and weight of the battery assembly 12 without reducing electrical capacity of the battery assembly 12.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A battery assembly having a positive terminal and a negative terminal, the battery assembly comprising:
a first structural member electrically coupled to the negative terminal of the battery assembly;
a second structural member electrically coupled to the positive terminal of the battery assembly;
a first battery cell electrically coupled to the negative terminal via the first structural member, the first battery cell electrically coupled to the positive terminal via the second structural member; and
a composite enclosure enveloping the first structural member, the second structural member, and the first battery cell, the first structural member and the second structural member being integral with the composite enclosure.

2. The battery assembly of claim 1, further comprising a third structural member disposed along a first side of the first battery cell and a fourth structural member disposed along a second side of the first battery cell.

3. The battery assembly of claim 2, wherein the first structural member extends along a first side of the composite enclosure, the second structural member extends along a second side of the composite enclosure, and the third structural member and the fourth structural member each extend from the first structural member to the second structural member.

4. The battery assembly of claim 2, further comprising a second battery cell electrically coupled to the first battery cell via the fourth structural member, the first battery cell electrically coupling the second battery cell to the negative terminal via the first structural member, and the second battery cell electrically coupling the first battery cell to the positive terminal via the second structural member.

5. The battery assembly of claim 4, further comprising a third battery cell electrically coupled to the negative terminal via the first structural member, a fourth battery cell electrically coupled to the positive terminal via the second structural member, a fifth structural member disposed between the third battery cell and the fourth battery cell, the third battery cell electrically coupled to the fourth battery cell via the fifth structural member.

6. The battery assembly of claim 5, wherein the first battery cell is electrically coupled in series with the second battery cell, the third battery cell is electrically coupled in series with the fourth battery cell, and the first battery cell and the second battery cell are together electrically coupled in parallel with the third battery cell and the fourth battery cell.

7. The battery assembly of claim 1, wherein the first structural member and the second structural member include at least one of (i) aluminum, (ii) steel, (iii) iron, and (iv) titanium.

8. The battery assembly of claim 1, wherein the first battery cell includes a plurality of battery cells electrically coupled to one another to form a battery cell array.

9. The battery assembly of claim 1, wherein the composite enclosure is configured to insulate each of the first structural member and the second structural member.

10. The battery assembly of claim 1, wherein the first battery cell is integral with the composite enclosure.

11. A vehicle including the battery assembly of claim 1.

12. A battery assembly including a positive terminal and a negative terminal, the battery assembly comprising:
a first structural member electrically coupled to the negative terminal of the battery assembly;
a second structural member electrically coupled to the positive terminal of the battery assembly;
a first battery cell electrically coupled to the negative terminal via the first structural member;
a third structural member electrically coupled to the first battery cell and disposed along a first side of the first battery cell;
a second battery cell electrically coupled in series with the first battery cell via the third structural member disposed along the first side of the first battery cell and a first side of the second battery cell, the second battery cell electrically coupled to the positive terminal via the second structural member; and
a composite enclosure enveloping the first structural member, the second structural member, the third structural member, the first battery cell, and the second battery cell, the first structural member, the second structural member, and the third structural member being integral with the composite enclosure.

13. The battery assembly of claim 12, wherein the first structural member extends along a first side of the composite enclosure, the second structural member extends along a second side of the composite enclosure, and the third structural member extends from the first structural member to the second structural member.

14. The battery assembly of claim 12, further comprising a fourth structural member disposed along a second side of the first battery cell opposite the first side of the first battery cell, and a fifth structural member disposed along a second side of the second battery cell opposite the first side of the second battery cell.

15. The battery assembly of claim 12, further comprising:
a third battery cell electrically coupled to the negative terminal via the first structural member;
a fourth battery cell electrically coupled to the positive terminal via the second structural member; and
a fourth structural member disposed between the third battery cell and the fourth battery cell, the third battery cell being electrically coupled in series with the fourth battery cell via the fourth structural member.

16. The battery assembly of claim 12, wherein the first structural member, the second structural member, and the third structural member include at least one of (i) aluminum, (ii) steel, (iii) iron, and (iv) titanium.

17. The battery assembly of claim 12, wherein the first battery cell includes a first plurality of battery cells electrically coupled to one another to form a first battery cell array, and the second battery cell includes a second plurality of battery cells electrically coupled to one another to form a second battery cell array.

18. The battery assembly of claim 12, wherein the composite enclosure includes plastic integrally formed about the first structural member, the second structural member, the first battery cell, and the second battery cell via plastic over-molding.

19. The battery assembly of claim 12, wherein the composite enclosure insulates each of the structural members and each of the battery cells.

20. A battery assembly for a vehicle and having a positive terminal and a negative terminal, the battery assembly including:
a first structural member extending along a first side of the battery assembly and electrically coupled to the negative terminal of the battery assembly;
a second structural member extending along a second side of the battery assembly and electrically coupled to the positive terminal of the battery assembly;
a first battery cell array electrically coupled to the negative terminal via the first structural member;
a third structural member disposed along a first side of the first battery cell array;
a second battery cell array electrically coupled to the positive terminal via the second structural member and electrically coupled in series with the first battery cell array via the third structural member disposed along the first side of the first battery cell array and a first side of the second battery cell array;
a fourth structural member disposed along a second side of the first battery cell array opposite the first side of the first battery cell array;
a fifth structural member disposed along a second side of the second battery cell array opposite the first side of the second battery cell array;
a third battery cell array electrically coupled to the negative terminal via the first structural member;
a fourth battery cell array electrically coupled to the positive terminal via the second structural member;
a sixth structural member disposed between the third battery cell array and the fourth battery cell array, the third battery cell array electrically coupled in series with the fourth battery cell array via the sixth structural member; and
a composite enclosure over-molded about each of the structural members and each of the battery cell arrays, the composite enclosure insulating each of the structural members and each of the battery cell arrays.
